(19) United States
(12) Patent Application Publication
(10) Pub. No.: US 2022/0251970 A1
(43) Pub. Date: Aug. 11, 2022

(54) TURBOCHARGER WITH ANTI-COKING COATING

(71) Applicant: GM Global Technology Operations LLC, Detroit, MI (US)

(72) Inventors: John A. Schultz, Troy, MI (US); Louis P. Begin, Rochester, MI (US)

(21) Appl. No.: 17/172,409

(22) Filed: Feb. 10, 2021

(51) Int. Cl. F01D 25/00; F01D 25/18; F01D 25/16; F01D 11/00

(52) U.S. Cl. CPC F01D 25/007; F01D 25/183; F01D 25/005; F01D 25/16; F05D 2260/98; F05D 2220/40; F05D 2240/50; F05D 2240/55; F05D 2260/95; F01D 11/00

(57) ABSTRACT

A turbocharger for an internal combustion engine includes a bearing housing defining a bearing bore, a bearing system within the bore having first and second bearings, a turbine shaft having first and second ends, the turbine shaft supported by the bearing system for rotation about an axis within the bore, a compressor wheel fixed to the turbine shaft proximate to the second end, a turbine wheel fixed to the turbine shaft proximate to the first end, a turbine rotor hub fixed to the turbine shaft and including at least one annular seal ring groove, an annular oil slinger groove, and a plurality of annular lands formed therein, and an anti-coking coating applied to annular lands immediately adjacent to the at least one seal ring groove.

### INTRODUCTION

The present disclosure relates to a turbocharger for an internal combustion engine within an automobile.

Coke deposition is a common issue in automotive lubrication systems exposed to high temperatures. Coke deposition can be caused by the catalytic-thermal degradation of hydrocarbon fluids; resulting in carbon becoming attached and building up as deposits on surfaces contacted by a fuel or oil. Carbon deposits may develop if the fluid circuit is operated at reduced flow rates or closed without the remaining stagnant fuel being purged. As the deposits collect; they can become sufficiently large to reduce or even obstruct fluid flow. In the case of a turbocharger, such carbon deposition can lead to degraded performance; reduced heat transfer efficiencies, and increased rates of material corrosion and erosion. Eventually, carbon deposits within a turbocharger may cause the turbocharger to seize up. This necessitates methods to prevent the build-up of carbon deposits and the use of expensive de-coking procedures.

Known turbochargers include cooling channels formed therein to reduce the temperature of the turbocharger during operation, thereby reducing the accumulation of carbon deposits. In addition, performance levels of the turbocharger may be governed to control how much heat is generated during operation, and prevent hot shut downs of the turbocharger.

Thus, while current turbochargers achieve their intended purpose, there is a need for a new and improved turbocharger that resists the accumulation of carbon deposits on the turbine shaft’

and allows the turbocharger to operate at higher temperatures.

### SUMMARY

According to several aspects of the present disclosure, a turbocharger for an internal combustion engine includes a bearing housing defining a bearing bore, a turbine shaft having a first end and a second end, the turbine shaft being supported by a bearing system for rotation about an axis within the bore, a bearing system disposed within the bore and supporting the turbine shaft, the bearing system including a first journal bearing arranged proximate to the first end of the turbine shaft and a second journal bearing arranged proximate to the second end of the turbine shaft, a compressor wheel fixed to the turbine shaft proximate to the second end and configured to pressurize an airflow being received from the ambient for delivery to the cylinder, a turbine wheel fixed to the turbine shaft proximate to the first end and configured to be rotated about the axis by post-combustion gases, a turbine rotor hub fixed to the turbine shaft and including an oil slinger groove in fluid communication with an oil circuit within the bearing housing, a first seal ring groove, a second seal ring groove, a first annular land, a second annular land, a third annular land and a fourth annular land, the first and second annular lands positioned on opposite sides of the oil slinger groove, the second and third annular lands positioned on opposite sides of the first seal ring groove and the third and fourth annular lands positioned on opposite sides of the second seal ring groove, a first seal positioned within the first seal ring groove and a second seal positioned within the second seal ring groove, the first and second seal adapted to prevent oil from passing between the bearing housing and the turbine rotor hub, and an anti-coking coating applied to the second, third and fourth annular lands.

According to another aspect, the anti-coking coating is further applied to the first annular land.

According to another aspect, the first and second seal ring grooves each include opposing axially facing sides and an annular floor, the anti-coking coating further being applied to the annular floor of each of the first and second seal ring grooves.

According to another aspect, the turbine wheel is welded onto the turbine shaft, the anti-coking coating further being applied to a weld filet between the turbine wheel and the turbine shaft.

According to another aspect, the turbine shaft is made from steel and the anti-coking coating is one of a ceramic and metallic plasma sprayed coating, a packed cementation coating, and a chemical vapor deposition coating.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of an internal combustion engine including a turbocharger according to an exemplary embodiment of the present disclosure;

FIG. 2 is a side sectional view of a turbocharger according to an exemplary embodiment of the present disclosure;

FIG. 3 is a side view of a turbine shaft according to an exemplary embodiment of the present disclosure; and

FIG. 4 is an enlarged view of a portion of the turbine shaft shown in FIG. 3.

### DETAILED DESCRIPTION

The following description is merely exemplary in nature and is not intended to limit the present disclosure, application, or uses.

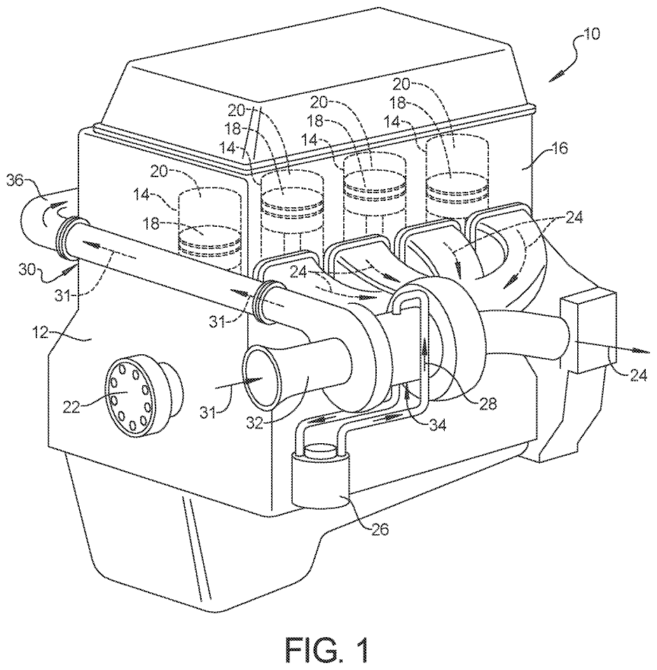

Referring to FIG. 1, an internal combustion engine 10 including a turbocharger 34 in accordance with the present disclosure includes a cylinder block 12 with a plurality of cylinders 14 arranged therein. As shown, the engine 10 also includes a cylinder head 16. Each cylinder 14 includes a piston 18 configured to reciprocate therein. Combustion chambers 20 are formed within the cylinders 14 between the bottom surface of the cylinder head 16 and the tops of the pistons 18. As known by those skilled in the art, combustion chambers 20 are configured to receive a fuel-air mixture for subsequent combustion therein.

The engine 10 also includes a crankshaft 22 configured to rotate within the cylinder block 12. The crankshaft 22 is rotated by the pistons 18 as a result of an appropriately proportioned fuel-air mixture being burned in the combustion chambers 20. After the air-fuel mixture is burned inside a specific combustion chamber 20, the reciprocating motion of a particular piston 18 serves to exhaust post-combustion gases 24 from the respective cylinder 14. The engine 10 also includes a fluid pump 26. The fluid pump 26 is configured to supply a lubricating fluid 28, such as engine oil. Accordingly, the fluid pump 26 may supply the lubricating fluid 28 to various bearings, such as that of the crankshaft 22. The fluid pump 26 may be driven directly by the engine 10, or by an electric motor (not shown).

The engine 10 additionally includes an induction system 30 configured to channel airflow 31 from the ambient to the cylinders 14. The induction system 30 includes an intake air duct 32, a turbocharger 34, and an intake manifold 36. Although not shown, the induction system 30 may additionally include an air filter upstream of the turbocharger 34 for removing foreign particles and other airborne debris from the airflow 31. The intake air duct 32 is configured to channel the airflow 31 from the ambient to the turbocharger 34, while the turbocharger is configured to pressurize the received airflow, and discharge the pressurized airflow to the intake manifold 36. The intake manifold 36, in turn, distributes the previously pressurized airflow 31 to the cylinders 14 for mixing with an appropriate amount of fuel and subsequent combustion of the resultant fuel-air mixture.

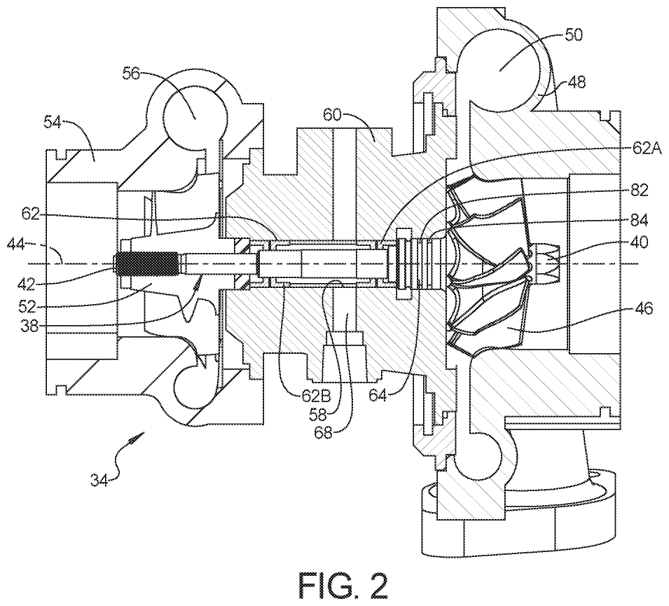

Referring to FIG. 2, the turbocharger 34 includes a steel turbine shaft 38 having a first end 40 and a second end 42. A turbine wheel 46 is mounted on the turbine shaft 38 proximate to the first end 40 and configured to be rotated along with the turbine shaft 38 about an axis 44 by post-combustion gases 24 emitted from the cylinders 14. The turbine wheel 46 is disposed within a turbine housing 48 that includes a volute or scroll 50. The scroll 50 receives the post-combustion exhaust gases 24 and directs the exhaust gases to the turbine wheel 46. The scroll 50 is configured to achieve specific performance characteristics, such as efficiency and response, of the turbocharger 34.

As further shown in FIG. 2, the turbocharger 34 also includes a compressor wheel 52 mounted on the turbine shaft 38 proximate to the second end 42. The compressor wheel 52 is configured to pressurize the airflow 31 being received from the ambient for eventual delivery to the cylinders 14. The compressor wheel 52 is disposed inside a compressor cover 54 that includes a volute or scroll 56. The scroll 56 receives the airflow 31 and directs the airflow to the compressor wheel 52. The scroll 56 is configured to achieve specific performance characteristics, such as peak airflow and efficiency of the turbocharger 34. Accordingly, rotation is imparted to the turbine shaft 38 by the post-combustion exhaust gases 24 energizing the turbine wheel 46, and is, in turn, communicated to the compressor wheel 52 owing to the compressor wheel 52 being fixed on the turbine shaft 38. As understood by those skilled in the art, the variable flow and force of the post-combustion exhaust gases 24 influences the amount of boost pressure that may be generated by the compressor wheel 52 throughout the operating range of the engine 10.

With continued reference to FIG. 2, the turbine shaft 38 is supported for rotation about the axis 44 within a bore 58 formed in a bearing housing 60 via a bearing system 62. The bearing system 62 is configured to control radial motion and vibrations of the turbine shaft 38. Furthermore, the bearing system 62 is configured to minimize a sub-synchronous resonance vibration of the turbine shaft 38. The bearing system 62 includes a first journal bearing 62A arranged proximate to the first end 40 of the turbine shaft 38 and a second journal bearing 62B arranged proximate to the second end 42 of the turbine shaft 38. The first journal bearing 62A and the second journal bearing 62B are lubricated and cooled by the supply of pressurized lubricating fluid 28 supplied via the fluid pump 26 to the bearing housing 60. The bearing housing 60 may be cast from a robust material such as iron in order to provide dimensional stability to the bore 58 under elevated temperatures and loads during operation of the turbocharger 34.

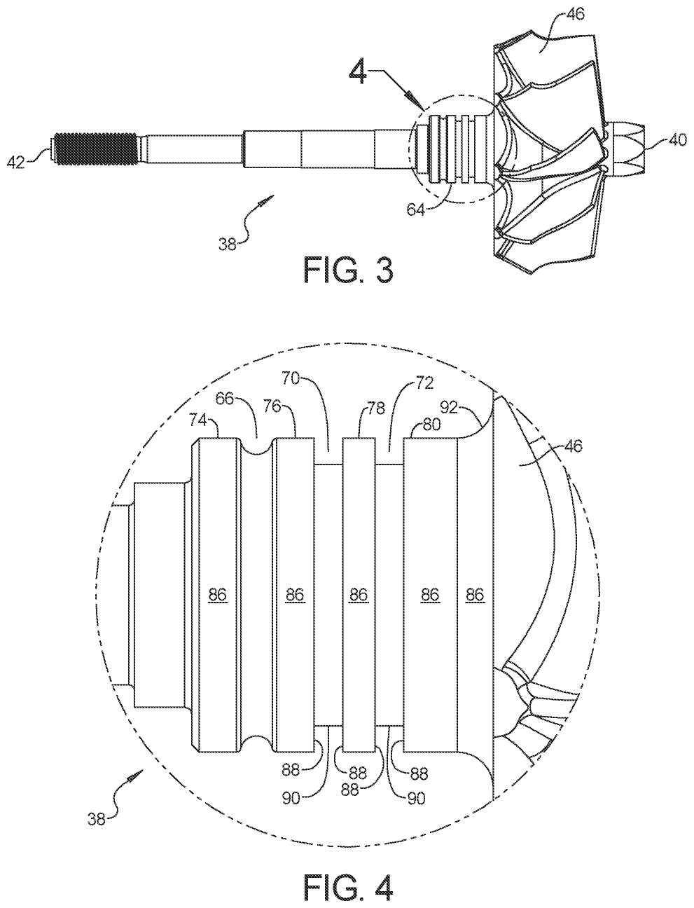

Referring to FIG. 3 and FIG. 4, the turbine shaft 38 includes a turbine rotor hub 64 fixed to the turbine shaft 38 and including an oil slinger groove 66 in fluid communication with an oil circuit 68 within the bearing housing 60, a first seal ring groove 70, a second seal ring groove 72, a first annular land 74, a second annular land 76, a third annular land 78 and a fourth annular land 80. The first and second annular lands 74, 76 are positioned on opposite sides of the oil slinger groove 66. The second and third annular lands 76, 78 are positioned on opposite sides of the first seal ring groove 70. The third and fourth annular lands 78, 80 are positioned on opposite sides of the second seal ring groove 72.

In an exemplary embodiment, as shown in FIG. 2, a first seal 82 is positioned within the first seal ring groove 70 and a second seal 84 is positioned within the second seal ring groove 72. The first and second seals 82, 84 are adapted to prevent oil from passing between the bearing housing 60 and the turbine rotor hub 64.

An anti-coking coating 86 is applied to the second, third and fourth annular lands 76, 78, 80. The anti-coking coating 86 prevents carbon deposits from building up on the second, third and fourth lands 76, 78, 80 during operation of the turbocharger due to high temperatures within the turbocharger. The anti-coking coating 86 may also be applied within the oil slinger groove 66. The anti-coking coating 86 is comprised of a elements that are resistant to the formation of carbon deposits under high temperatures. The anti-coking coating 86 may be formed by any known methods or chemical structures that are known to have carbon deposit resistant qualities. By way of non-limiting examples, the anti-coking coating 86 may be one of, a ceramic and metallic plasma sprayed coating, a packed cementation coating, and a chemical vapor deposition (CVD) coating. Such anti-coking coatings 86 may include elemental structures such as, but not limited to, aluminide, SiO2, glass based coatings, chromium packed cementation coatings, and TiC+SiC CVD coating.

Other examples of anti-coking coatings include an inner layer; which may be a ceramic material, applied to a surface, over which an outer layer, which may be platinum, is deposited. The inner layer may serve as a diffusion barrier layer that separates the outer layer from the surface on which the anti-coke coating is deposited. The outer layer hinders carbon deposits from sticking to the surface, and in some forms may serve as a catalyst to form nonadherent particles, thereby reducing coking and deposit buildup. With the anti-coke coating in place, small flakes of coke quickly spall from the surface with little risk of blocking small orifices or metering passages that may exist downstream. Such anti-coke coatings may further contain additional layers as long as the hydrocarbon fluid contacts the outermost layer, which, in certain embodiments, may comprise or consist of platinum. It should be understood that the novel aspects of the present disclosure are applicable to the use of any suitable anti-coking coatings that currently exist or may be developed in the future.

The entire turbine rotor hub 64 experiences high temperatures during operation of the turbochargers 34, and any of the radially outward facing surfaces of the turbine rotor hub 64 are susceptible to the formation of carbon deposits. In an exemplary embodiment, the anti-coking coating 86 is further applied to the first annular land 74, adjacent the oil slinger groove 66 proximate to the second end 42 of the turbine shaft 38. The first and second seal ring grooves 70, 72 each include opposing axially facing sides 88 and an annular floor 90. In another exemplary embodiment, the anti-coking coating 86 is also applied to the annular floor 90 of each of the first and second seal ring grooves 70, 72. Build up of carbon deposits on the axially facing sides 88 is less severe, and the spacing between opposing axially facing sides 88 are held to tight tolerance. The anti-coking coating may also be applied to the axially facing sides 88 of the seal ring grooves 70, 72, within tolerances. Anti-coking coating 86 applied to the axially facing sides 88 will provide a slight additional benefit in addition to the anti-coking coating 86 applied to the radially outward facing surfaces.

In still another exemplary embodiment, the turbine wheel 46 is welded onto the turbine shaft 38. The anti-coking coating 86 is applied to a weld filet 92 between the turbine wheel 46 and the turbine shaft 38.

A turbocharger 34 of the present disclosure offers several advantages. By applying an anti-coking coating to the first, second, third and fourth annular lands and the weld filet between the turbine wheel 46 and the turbine shaft 38, formation of carbon deposits on the turbine rotor hub 64 is minimized. This allows the turbocharger 34 to be operated without taking conventional measures to reduce the amount of heat created at the turbine rotor hub 64, such as cooling channels within the bearing housing. A turbocharger in accordance with the present disclosure would also be able to operate at higher temperatures and higher performance levels and would not be affected by hot shut downs. Additionally, a turbocharger in accordance with the present disclosure may be able to operate without having cooling channels formed therein, which would dramatically reduce the overall cost of the turbocharger. The cost of the turbocharger is reduced further by eliminating the need for flange port machining and threaded holes needed for attaching coolant pipes. The cost of the engine is reduced by eliminating coolant being routed to the turbocharger and the accompanying fasteners, gaskets, and machining needed on mating components. Furthermore, a turbocharger of the present disclosure will not add heat to the engine cooling system, allowing the engine cooling system to be design and to operate more efficiently.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A turbocharger for an internal combustion engine, the turbocharger comprising:
a bearing housing defining a bearing bore;
a bearing system disposed within the bearing bore and having a first bearing and a second bearing;
a turbine shaft having a first end and a second end, the turbine shaft being supported by the bearing system for rotation about an axis within the bearing bore;
a compressor wheel fixed to the turbine shaft proximate to the second end and configured to pressurize an airflow being received from the ambient for delivery to a cylinder;
a turbine wheel fixed to the turbine shaft proximate to the first end and configured to be rotated about the axis by post-combustion gases;
a turbine rotor hub fixed to the turbine shaft and including at least one annular seal ring groove, an annular oil slinger groove, and a plurality of annular lands formed therein; and
an anti-coking coating applied to the plurality of annular lands immediately adjacent to the at least one annular seal ring groove.

2. The turbocharger of claim 1, wherein the at least one annular seal ring groove of the turbine rotor hub includes a first seal ring groove, and a second seal ring groove, and the plurality of annular lands includes a first annular land, a second annular land, a third annular land and a fourth annular land, the first and second annular lands positioned on opposite sides of the oil slinger groove, the second and third annular lands positioned on opposite sides of the first seal ring groove and the third and fourth annular lands positioned on opposite sides of the second seal ring groove, the anti-coking coating being applied to the second, third and fourth annular lands.

3. The turbocharger of claim 2, wherein the anti-coking coating is further applied to the first annular land.

4. The turbocharger of claim 2, wherein the first and second seal ring grooves each include opposing axially facing sides and an annular floor, the anti-coking coating further being applied to the annular floor of each of the first and second seal ring grooves.

5. The turbocharger of claim 2, wherein the turbine wheel is welded onto the turbine shaft, the anti-coking coating further being applied to a weld filet between the turbine wheel and the turbine shaft.

6. The turbocharger of claim 2, wherein the turbine shaft is made from steel and the anti-coking coating is one of a ceramic and metallic plasma sprayed coating, a packed cementation coating, and a chemical vapor deposition coating.

7. The turbocharger of claim 2, further including a first seal positioned within the first seal ring groove and a second seal positioned within the second seal ring groove, the first and second seals adapted to prevent oil from passing between the bearing housing and the turbine rotor hub.

8. The turbocharger of claim 2, wherein the oil slinger groove is in fluid communication with an oil circuit within the bearing housing.

9. The turbocharger of claim 1, wherein the first bearing is a journal bearing arranged proximate to the first end of the turbine shaft and the second bearing is a journal bearing arranged proximate to the second end of the turbine shaft.

10. A turbine shaft assembly for a turbocharger for an internal combustion engine, the turbine shaft assembly comprising:
a turbine shaft having a first end and a second end, the turbine shaft being supported by a bearing system for rotation about an axis within a bore within a bearing housing of the turbocharger;
a compressor wheel fixed to the turbine shaft proximate to the second end;
a turbine wheel fixed to the turbine shaft proximate to the first end;
a turbine rotor hub fixed to the turbine shaft and including at least one annular seal ring groove, an annular oil slinger groove, and a plurality of annular lands formed therein; and
an anti-coking coating applied to the plurality of annular lands immediately adjacent to the at least one annular seal ring groove.

11. The turbine shaft assembly of claim 10, wherein the at least one annular seal ring groove of the turbine rotor hub includes a first seal ring groove, and a second seal ring groove, and the plurality of annular lands includes a first annular land, a second annular land, a third annular land and a fourth annular land, the first and second annular lands positioned on opposite sides of the oil slinger groove, the second and third annular lands positioned on opposite sides of the first seal ring groove and the third and fourth annular lands positioned on opposite sides of the second seal ring groove, the anti-coking coating being applied to the second, third and fourth annular lands.

12. The turbine shaft assembly of claim 11, wherein the anti-coking coating is further applied to the first annular land.

13. The turbine shaft assembly of claim 11, wherein the first and second seal ring grooves each include opposing axially facing sides and an annular floor, the anti-coking coating further being applied to the annular floor of each of the first and second seal ring grooves.

14. The turbine shaft assembly of claim 11, wherein the turbine wheel is welded onto the turbine shaft, the anti-coking coating further being applied to a weld filet between the turbine wheel and the turbine shaft.

15. The turbine shaft assembly of claim 11, wherein the turbine shaft is made from steel and the anti-coking coating is one of an aluminide coating, SiO2, and a glass-based coating.

16. A turbocharger for an internal combustion engine, the turbocharger comprising:
a bearing housing defining a bearing bore;
a turbine shaft having a first end and a second end, the turbine shaft being supported by a bearing system for rotation about an axis within the bearing bore;
the bearing system disposed within the bearing bore and supporting the turbine shaft, the bearing system including a first journal bearing arranged proximate to the first end of the turbine shaft and a second journal bearing arranged proximate to the second end of the turbine shaft;
a compressor wheel fixed to the turbine shaft proximate to the second end and configured to pressurize an airflow being received from the ambient for delivery to a cylinder;
a turbine wheel fixed to the turbine shaft proximate to the first end and configured to be rotated about the axis by post-combustion gases;
a turbine rotor hub fixed to the turbine shaft and including an oil slinger groove in fluid communication with an oil circuit within the bearing housing, a first seal ring groove, a second seal ring groove, a first annular land, a second annular land, a third annular land and a fourth annular land, the first and second annular lands positioned on opposite sides of the oil slinger groove, the second and third annular lands positioned on opposite sides of the first seal ring groove and the third and fourth annular lands positioned on opposite sides of the second seal ring groove;
a first seal positioned within the first seal ring groove and a second seal positioned within the second seal ring groove, the first and second seals adapted to prevent oil from passing between the bearing housing and the turbine rotor hub; and
an anti-coking coating applied to the second, third and fourth annular lands.

17. The turbocharger of claim 16, wherein the anti-coking coating is further applied to the first annular land.

18. The turbocharger of claim 17, wherein the first and second seal ring grooves each include opposing axially facing sides and an annular floor, the anti-coking coating further being applied to the annular floor of each of the first and second seal ring grooves.

19. The turbocharger of claim 18, wherein the turbine wheel is welded onto the turbine shaft, the anti-coking coating further being applied to a weld filet between the turbine wheel and the turbine shaft.

20. The turbocharger of claim 19, wherein the turbine shaft is made from steel and the anti-coking coating is one of a ceramic and metallic plasma sprayed coating, a packed cementation coating, and a chemical vapor deposition coating.
